(19) United States
(12) Patent Application Publication
(10) Pub. No.: US 2026/0088711 A1
(43) Pub. Date: Mar. 26, 2026

(54) QUASI-RESONANT FORCED CONTINUOUS CONDUCTION MODE POWER CONVERTERS

(71) Applicant: Apple Inc., Cupertino, CA (US)

(72) Inventors: Jonathan D Paolucci, Santa Clara, CA (US); Bo Xu, Saratoga, CA (US); Kevin Ho, San Jose, CA (US); Yanhui Xie, Cupertino, CA (US); Nathan Y Tang, Oakland, CA (US); Jingdong Chen, San Jose, CA (US)

(21) Appl. No.: 18/897,501

(22) Filed: Sep. 26, 2024

(51) Int. Cl. H02M 1/38; H02M 3/00; H02M 3/158

(52) U.S. Cl. CPC H02M 1/385; H02M 3/003; H02M 3/158

(57) ABSTRACT

A power converter can include a switching half-bridge having a top switch (TSW) and a bottom switch (BSW) coupled at a switch node; an energy storage element coupled to the switch node; and control circuitry that operates the switches in a fixed frequency PWM forced CCM with an adjustable dead time (DT) between turning off one switch and turning on another switch; monitors a load current of the power converter corresponding to a current through the energy storage element; and responsive to a load current greater than a first threshold, sets the adjustable DT to minimum DT; responsive to a load current less than a second threshold, sets the adjustable DT to a maximum DT; and responsive to a load current between the first and second thresholds, sets the adjustable DT to an intermediate DT between the minimum DT and the maximum DT.

### BACKGROUND

Switching power supplies may be employed in a variety of applications. In many of these applications it may be desirable to maximize operating efficiency of the power supply. However, in some applications, other considerations, such as transient response, frequency content of switching noise associated with the power supply, etc. may prevent efficiency optimizations that could be used in applications without such constraints.

### SUMMARY

Thus, it may be desirable to provide other efficiency enhancement techniques for switching power supplies in certain applications.

A power converter can include a switching half-bridge having a top switch and a bottom switch coupled at a switch node; an energy storage element coupled to the switch node; and control circuitry that: operates the top switch and bottom switch in a fixed frequency pulse width modulation forced continuous conduction mode with an adjustable dead time between turning off one of the top and bottom switches and turning on another of the top and bottom switches; monitors a load current of the power converter, the load current corresponding to a current through the energy storage element; and responsive to a load current greater than a first threshold, sets the adjustable dead time to minimum dead time value; responsive to a load current less than a second threshold, sets the adjustable dead time to a maximum dead time value; and responsive to a load current between the first and second thresholds, sets the adjustable dead time to an intermediate dead time value between the minimum dead time value and the maximum dead time value.

The intermediate dead time value is scaled to the load current. The adjustable dead time can be a dead time between turning off the bottom switch and turning on the top switch. The switching half bridge, first circuitry, and second circuitry can be a single integrated circuit. The switching half bridge, first circuitry, and second circuitry can be contained in a single package. The energy storage element can be an inductor. The power converter can be a buck converter. The load current can be an average current through the inductor. The load current can be an average current through the energy storage element.

Control circuitry for a power converter can include first circuitry that operates a top switch and bottom switch of a switching half bridge in a fixed frequency pulse width modulation forced continuous conduction mode with an adjustable dead time between turning off one of the top and bottom switches and turning on another of the top and bottom switches; second circuitry that monitors a load current of the power converter, the load current corresponding to a current through an energy storage element coupled to a switch node of the switching half bridge; and responsive to a load current greater than a first threshold, sets the adjustable dead time to minimum dead time value; responsive to a load current less than a second threshold, sets the adjustable dead time to a maximum dead time value; and responsive to a load current between the first and second thresholds, sets the adjustable dead time to an intermediate dead time value between the minimum dead time value and the maximum dead time value.

The intermediate dead time value can be scaled to the load current. The adjustable dead time can be a dead time between turning off the bottom switch and turning on the top switch. The switching half bridge, first circuitry, and second circuitry can be a single integrated circuit. The switching half bridge, first circuitry, and second circuitry can be contained in a single package. The energy storage element can be an inductor, and the power converter can be a buck converter. The load current can be an average current through the inductor. The load current can be an average current through the energy storage element.

A method of controlling a power converter, performed by control circuitry of the power converter, can include operating a top switch and bottom switch of a switching half bridge in a fixed frequency pulse width modulation forced continuous conduction mode with an adjustable dead time between turning off one of the top and bottom switches and turning on another of the top and bottom switches; monitoring a load current of the power converter, the load current corresponding to a current through an energy storage element coupled to a switch node of the switching half bridge; and responsive to a load current greater than a first threshold, setting the adjustable dead time to minimum dead time value; responsive to a load current less than a second threshold, setting the adjustable dead time to a maximum dead time value; and responsive to a load current between the first and second thresholds, setting the adjustable dead time to an intermediate dead time value between the minimum dead time value and the maximum dead time value.

The intermediate dead time value can be scaled to the load current. The adjustable dead time can be a dead time between turning off the bottom switch and turning on the top switch. The load current can be an average current through the energy storage element.

### BRIEF DESCRIPTION OF THE DRAWINGS

FIG. 1 illustrates a block diagram of an electronic device.

FIGS. 2A & 2B illustrate a power system of an electronic device.

FIG. 3 illustrates load current of a power system of an electronic device under various load conditions.

FIG. 4 illustrates relationships between losses and dead time between switching events for an example switching converter under heavy load and light load conditions.

FIG. 5 illustrates load current operating regions for a switching converter and desired dead times corresponding thereto.

FIG. 6 further illustrates load current regions and dead time selection by control circuitry of a power converter.

FIG. 7 illustrates a flow chart of a dead time selection technique that can be employed by a switching power converter.

FIG. 8 illustrates an example efficiency plot for switching converters using fixed dead time versus adaptive dead time as described herein.

### DETAILED DESCRIPTION

In the following description, for purposes of explanation, numerous specific details are set forth to provide a thorough understanding of the disclosed concepts. As part of this description, some of this disclosure's drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

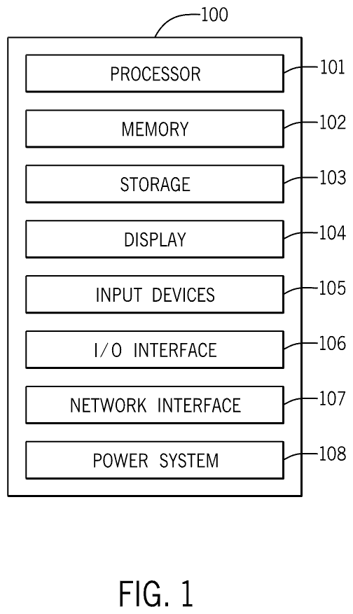

FIG. 1 is a block diagram of an electronic device 100, according to embodiments of the present disclosure. The electronic device 100 may include, among other things, one or more processors 101 (collectively referred to herein as a single processor for convenience, which may be implemented in any suitable form of processing circuitry), memory 102, nonvolatile storage 103, a display 104, input devices 105, an input/output (I/O) interface 106, a network interface 107, and a power system 108. The various functional blocks shown in FIG. 1 may include hardware elements (including circuitry), software elements (including machine-executable instructions), or a combination of both hardware and software elements (which may be referred to as logic). The processor 101, memory 102, the nonvolatile storage 103, the display 104, the input devices 105, the input/output (I/O) interface 106, the network interface 107, and/or the power system 108 may each be communicatively coupled directly or indirectly (e.g., through or via another component, a communication bus, a network, etc.) to one another to transmit and/or receive data amongst one another. It should be noted that FIG. 1 is merely one example of a particular implementation and is intended to illustrate the types of components that may be present in the electronic device 100.

By way of example, the electronic device 100 may include any suitable computing device, including a desktop or laptop/notebook, a portable electronic or handheld electronic device such as a wireless electronic device or smartphone, a tablet computer, a wearable electronic device such as a smart watch or head mounted display, and other similar devices.

Processor 101 and other related items in FIG. 1 may be embodied wholly hardware or by hardware programmed to execute suitable software instructions. Furthermore, the processor 101 and other related items in FIG. 1 may be a single contained processing module or may be incorporated wholly or partially within any of the other elements within the electronic device 100. Processor 101 may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that may perform calculations or other manipulations of information. Processor 101 may include one or more application processors, one or more baseband processors, or both, and perform the various functions described herein.

In the electronic device 100 of FIG. 1, processor 101 may be operably coupled with a memory 102 and a nonvolatile storage 103 to perform various algorithms. Such programs or instructions executed by processor 101 may be stored in any suitable article of manufacture that includes one or more tangible, computer-readable media. The tangible, computer-readable media may include the memory 102 and/or the nonvolatile storage 103, individually or collectively, to store the instructions or routines. The memory 102 and the nonvolatile storage 103 may include any suitable articles of manufacture for storing data and executable instructions, such as random-access memory, read-only memory, rewritable flash memory, hard drives, and optical discs. In addition, programs (e.g., an operating system) encoded on such a computer program product may also include instructions that may be executed by processor 101 to enable the electronic device 100 to provide various functionalities.

In certain embodiments, the display 104 may facilitate users to view images generated on the electronic device 100. In some embodiments, the display 104 may include a touch screen, which may facilitate user interaction with a user interface of the electronic device 100. Furthermore, it should be appreciated that, in some embodiments, the display 104 may include one or more liquid crystal displays (LCDs), light-emitting diode (LED) displays, organic light-emitting diode (OLED) displays, active-matrix organic light-emitting diode (AMOLED) displays, or some combination of these and/or other display technologies.

The input devices 105 of the electronic device 100 may enable a user to interact with the electronic device 100 (e.g., pressing a button to increase or decrease a volume level). The I/O interface 106 may enable the electronic device 100 to interface with various other electronic devices, as may the network interface 107. In some embodiments, the I/O interface 106 may include an I/O port for a hardwired connection for charging and/or content manipulation using a standard connector and protocol, such as a universal serial bus (USB), or other similar connector and protocol. The network interface 107 may include, for example, one or more interfaces for a personal area network (PAN), such as an ultra-wideband (UWB) or a BLUETOOTH® network, a local area network (LAN) or wireless local area network (WLAN), such as a network employing one of the IEEE 802.11x family of protocols (e.g., WI-FI®), and/or a wide area network (WAN), such as any standards related to the Third Generation Partnership Project (3GPP), including, for example, a 3^{rd} generation (3G) cellular network, universal mobile telecommunication system (UMTS), 4^{th} generation (4G) cellular network, long term evolution (LTE®) cellular network, long term evolution license assisted access (LTE-LAA) cellular network, 5^{th} generation (5G) cellular network, and/or New Radio (NR) cellular network, a 6th generation (6G) or greater than 6G cellular network, a satellite network, a non-terrestrial network, and so on. In particular, the network interface 107 may include, for example, one or more interfaces for using a cellular communication standard of the 5G specifications that include the millimeter wave (mmWave) frequency range (e.g., 24.25-300 gigahertz (GHz)) that defines and/or enables frequency ranges used for wireless communication. The network interface 107 of the electronic device 100 may allow communication over the aforementioned networks (e.g., 5G, Wi-Fi, LTE-LAA, and so forth).

The network interface 107 may also include one or more interfaces for, for example, broadband fixed wireless access networks (e.g., WIMAX®), mobile broadband Wireless networks (mobile WIMAX®), asynchronous digital subscriber lines (e.g., ADSL, VDSL), digital video broadcasting-terrestrial (DVB-T®) network and its extension DVB Handheld (DVB-H®) network, ultra-wideband (UWB) network, alternating current (AC) power lines, and so forth.

The power system 108 of the electronic device 100 may include any suitable source of power, such as a rechargeable battery (e.g., a lithium ion or lithium polymer (Li-poly) battery) and/or a power converter, including a DC/DC power converter, an AC/DC power converter, a power adapter (which may be external), etc.

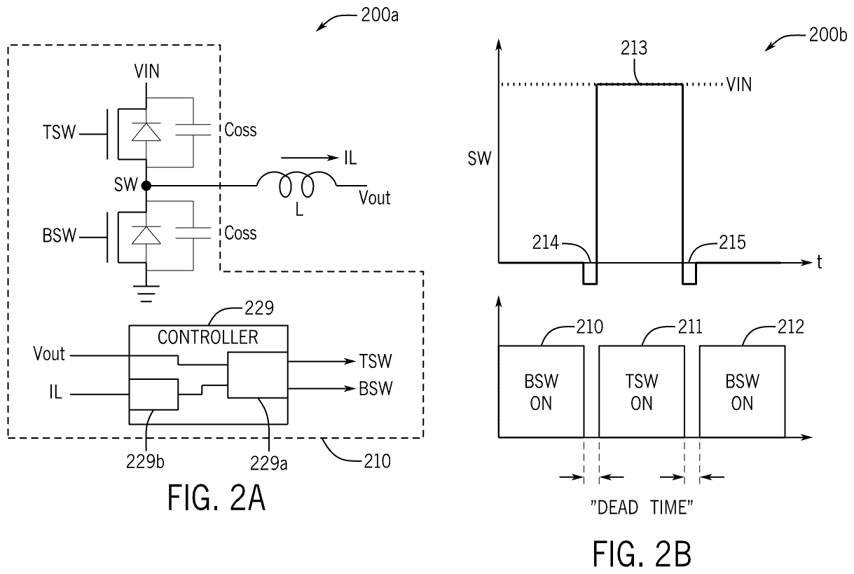

FIGS. 2A & 2B illustrate a simplified schematic 200a of an example power system of an electronic device and associated switching events 200b for the power system. The power system can include a switching converter. FIG. 2A illustrates a simplified schematic 200a of a synchronous buck converter. However, in some embodiments, other converter topologies could also be used, such as multi-phase buck converters, boost converters, buck-boost converters, switched capacitor converters, charge pumps, etc. The example (synchronous) buck converter includes a switching half bridge that can include a top or high side switching device TSW and a bottom or low side switching device BSW. The switching half bridge can be coupled across the input voltage VIN, i.e., between VIN and ground, with the output of the converter being taken at the switch node SW.

Throughout this description, TSW and BSW are used to respectively refer to both the top switching device (“top switch”) and bottom switching device (“bottom switch”) as well as their respective drive or control signals. Additionally, top switch TSW and bottom switch BSW are depicted as being metal oxide semiconductor field effect (MOSFET) devices, which are depicted as including an integral body diode and parasitic capacitance Coss. In some embodiments other types of switching devices could be used. The devices can be implemented using any semiconductor technology suitable for the application, including silicon (Si) devices, silicon carbide (SiC) devices, gallium nitride (GaN) devices, etc.

Also included in power system 200a is an output inductor L. Top and bottom switches TSW/BSW can be operated by control circuitry 229 to produce a regulated output voltage Vout by alternately switching to couple the output inductor L to the input voltage and ground, resulting in an output current IL through the inductor. Top and bottom switches TSW/BSW can be switched alternately and substantially complementarily, such that only one switch is on at a given time and one switch is always on except for a relatively short dead time between turn off of one switch and turn off of the other, as described in greater detail below. An example switching event sequence is depicted in plot 200b of FIG. 2B, which plots the switch node voltage versus time. Initially, bottom switch BSW can be turned on (interval 210) resulting in the switch node SW being coupled to ground, or, in other words, the voltage at switch node SW is zero. Then, bottom switch BSW can turn off, followed by a short dead time before turning on top switch TSW (interval 211), which creates the on pulse 213. Because of the short dead time, the voltage of the switch node will briefly drop (interval 214) before rising to the input voltage VIN, where it will remain for the duration of the top switch on time 211. Then, top switch TSW can turn off, ending on pulse 213, followed by another short dead time, subsequently followed by the bottom switch again turning on (interval 212). During this latter dead time 215, the voltage of the switch node may again dip negative duc to the inductor/load current IL.

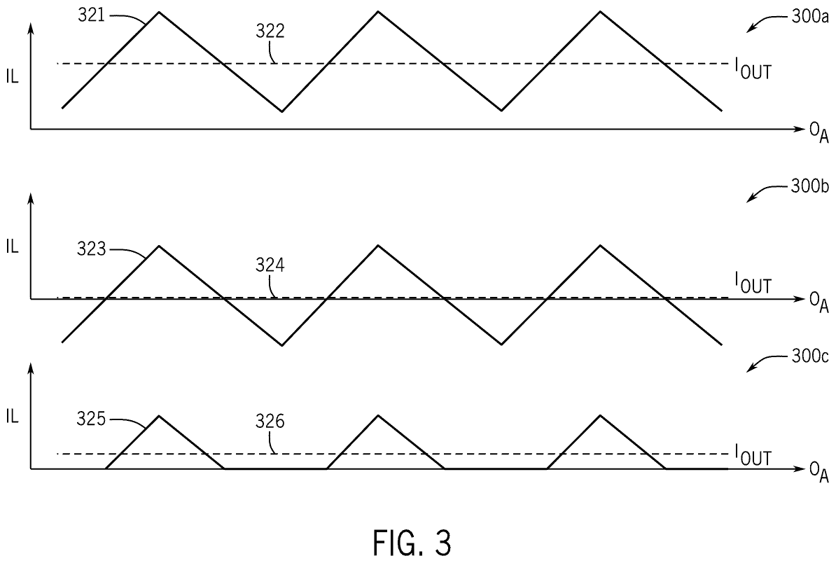

Turning back to FIG. 2A, control circuitry 229 can monitor the output voltage via circuitry 229a operates the switches in a fixed frequency pulse width modulation forced continuous conduction mode. In some applications, such as power supplies for display systems, a fixed frequency mode of operation may be desirable because it can result in more predictable frequency content of the switching noise. Additionally, forced continuous conduction mode (described further below with reference to FIG. 3) may be desirable in such applications because it can allow for improved transient response. Control circuitry 229 can also include current monitoring circuitry 229b that can monitor the load current IL and adjust the dead time between switching events as described in greater detail below. Control circuitry 229 can be implemented using any appropriate circuitry, including analog, digital, and/or programmable or programmed circuitry (such as a microcontroller and associated firmware) that implement the control strategy described herein. This circuitry can be formed from discrete components and/or one or more integrated circuits, including application specific integrated circuits (ASICs) specifically constructed to provide the functionality described herein. In some cases, the switching bridge itself could also be part of the integrated circuit or integrated circuit package containing the control circuitry.

FIG. 3 illustrates load current of a power system of an electronic device under various load conditions. As noted above, a forced continuous conduction mode (FCCM) may be desirable in some applications, such as power supplies for display systems, because of their transient response characteristics. Plot 300a of FIG. 3 illustrates load current 321 versus time for a FCCM operation at a relatively higher load condition (i.e., heavy load) as compared to the relatively lighter load conditions described below. The load current 321 is a triangular waveform that increases when the top switch TSW is closed, allowing increasing load current (i.e., current IL through inductor L) to be driven by the input voltage, storing energy in the inductor. Instantaneous load current decreases when the bottom switch BSW is closed, as energy stored in the inductor is discharged to the load. The average current IOUT 322 is thus delivered to the load being powered by the power supply.

Plot 300b of FIG. 3 illustrates load current 323 versus time for a FCCM operation at a relatively lower load condition (i.e., light load). The load current 323 is again a triangular waveform that increases when the top switch TSW is closed, allowing increasing load current (i.e., current IL through inductor L) to be driven by the input voltage, storing energy in the inductor. Instantaneous load current decreases when the bottom switch BSW is closed, as energy stored in the inductor is discharged to the load. The average current IOUT 324 is thus delivered to the load being powered by the power supply. In this lighter load condition, the average current IOUT is sufficiently low that the instantaneous current dips negative during certain intervals.

In each of the two previous conditions, the forced continuous conduction mode means that current is always flowing through the inductor. Plot 300c of FIG. 3 illustrates load current 325 in a diode emulation mode (as opposed to FCCM). In the diode emulation mode, operation of the switching devices is controlled such that the load current does not go negative, thus, when the bottom switch is opened, and the instantaneous load current reaches zero, the switching operation prevents reverse current flow through the inductor L (preventing current flow from the load back to the input). Still, the average of the load current IOUT 326 remains. Under some load conditions, this diode emulation mode can improve operating efficiency; however, with the potential loss of some of the transient response advantages of FCCM.

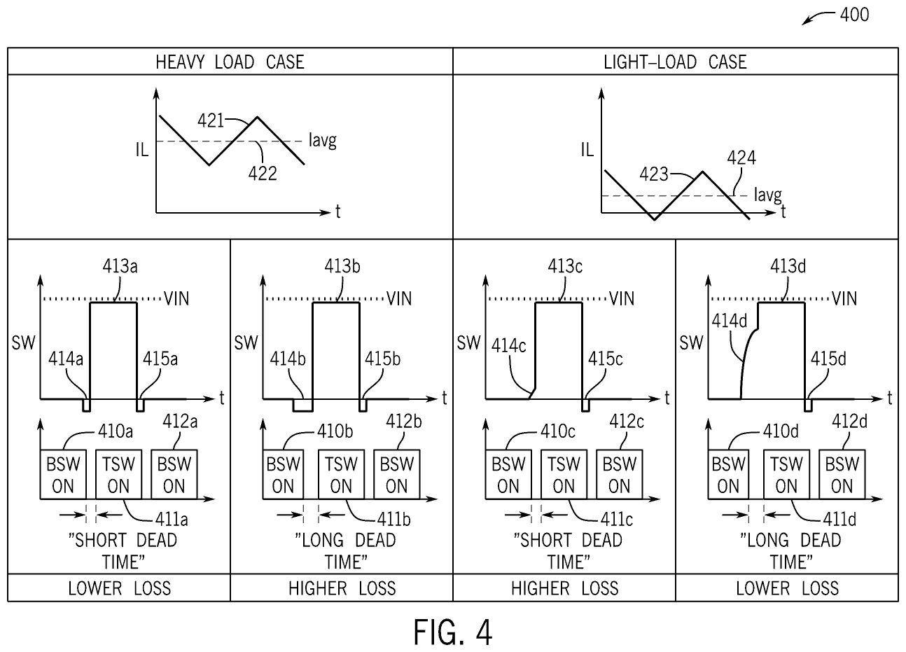

FIG. 4 illustrates relationships between losses and dead time between switching events for an example switching converter under heavy load and light load conditions in the form of a table 400. The left-hand columns of table 400 depict a heavy load condition corresponding to a relatively higher average load current lavg 422 such that the FCCM instantaneous current 421 never becomes negative. The right-hand columns of table 400 depict a light load condition corresponding to a relatively lower average load current lavg 424 such that the FCCM instantaneous current 423 does periodically become negative.

Under heavy load conditions, a short dead time (left-most column) can result in relatively lower losses. The plot of on times of the respective switches and corresponding switch node voltages correspond to the one described above with respect to FIG. 2B and include similar reference numbers. Thus, bottom switch BSW can initially be turned on (interval 410a) resulting in the switch node SW being coupled to ground, or, in other words, the voltage at switch node SW is zero. Then, bottom switch BSW can turn off, followed by a short dead time before turning on top switch TSW (interval 411a), which creates the on pulse 413a. Because of the short dead time, the voltage of the switch node will briefly drop (interval 414a) before rising to the input voltage VIN, where it will remain for the duration of the top switch on time 411a. Then, top switch TSW can turn off, ending on pulse 413a, followed by another short dead time, subsequently followed by the bottom switch again turning on (interval 412a). During this latter dead time 415a, the voltage of the switch node may again dip negative due to the inductor/load current IL.

Conversely, a long dead time (left-center column) can result in relatively higher losses. The plot of on times of the respective switches and corresponding switch node voltages correspond to those described above and include similar reference numbers. Thus, bottom switch BSW can initially be turned on (interval 410b) resulting in the switch node SW being coupled to ground, or, in other words, the voltage at switch node SW is zero. Then, bottom switch BSW can turn off, followed by a short dead time before turning on top switch TSW (interval 411b), which creates the on pulse 413b. Because of the long dead time, the voltage of the switch node will drop below zero for a longer time (interval 414b) before rising to the input voltage VIN, where it will remain for the duration of the top switch on time 411b. Then, top switch TSW can turn off, ending on pulse 413b, followed by another short dead time, subsequently followed by the bottom switch again turning on (interval 412b). During this latter dead time 415b, the voltage of the switch node may again dip negative due to the inductor/load current IL.

During the dead time intervals, both switches are turned off, but the FCCM means current is still flowing, e.g., through a body diode of one of the switching devices. This can result in higher conduction losses during such interval than if the current were flowing through a turned-on switching device. Because of the longer dead time interval between switching intervals 410b and 411b versus the shorter dead time interval between switching intervals 410a and 411a, the losses in the long dead time case are higher under heavy load conditions.

This situation can be reversed under light load conditions, as illustrated on the right-hand side of table 400. Under light load conditions, a short dead time (right-center column) can result in relatively higher losses. The plot of on times of the respective switches and corresponding switch node voltages correspond to those described above and include similar reference numbers. Thus, bottom switch BSW can initially be turned on (interval 410c) resulting in the switch node SW being coupled to ground, or, in other words, the voltage at switch node SW is zero. Then, bottom switch BSW can turn off, followed by a short dead time before turning on top switch TSW (interval 411c), which creates the on pulse 413c. Because of the short dead time, the voltage of the switch node will briefly and slightly rise (interval 414c) before rising to the input voltage VIN, where it will remain for the duration of the top switch on time 411c. Then, top switch TSW can turn off, ending on pulse 413c, followed by another short dead time, subsequently followed by the bottom switch again turning on (interval 412c). During this latter dead time 415c, the voltage of the switch node may dip negative due to the inductor/load current IL.

Conversely, a long dead time (right-most column) can result in relatively lower losses. The plot of on times of the respective switches and corresponding switch node voltages correspond to those described above and include similar reference numbers. Thus, bottom switch BSW can initially be turned on (interval 410d) resulting in the switch node SW being coupled to ground, or, in other words, the voltage at switch node SW is zero. Then, bottom switch BSW can turn off, followed by a short dead time before turning on top switch TSW (interval 411d), which creates the on pulse 413d. Because of the long dead time, the voltage of the switch node will rise for a longer time (interval 414d) before top switch TSW is closed, allowing it to finish rising to the input voltage VIN, where it will remain for the duration of the top switch on time 411d. Then, top switch TSW can turn off, ending on pulse 413d, followed by another short dead time, subsequently followed by the bottom switch again turning on (interval 412d). During this latter dead time 415d, the voltage of the switch node may again dip negative due to the inductor/load current IL.

During the dead time intervals, e.g., those between turning off bottom switch BSW and turning on top switch TSW, both switches are turned off, but the FCCM means current is still flowing, e.g., through a body diode of one of the switching devices. This can allow the ringing caused by resonance between the output inductor L and the output capacitance to allow the voltage at switch node SW to rise, which can reduce the switching losses associated with turning on top switch TSW. Such switching losses can be minimized if the dead time is selected to correspond to ¼-cycle of the resonant ringing described above. As a result, a longer dead time—to a degree—can result in lower net losses under light load conditions. As a general principle, the dead time needs to be sufficiently long to allow the negative current to charge the parasitic capacitance of the top switch to as near the input voltage as possible (e.g., corresponding to something near ¼-cycle of the resonant ring), which can be accomplished by adjusting the dead time responsive to the load current, which is indicative of the lightness/heaviness of the load condition.

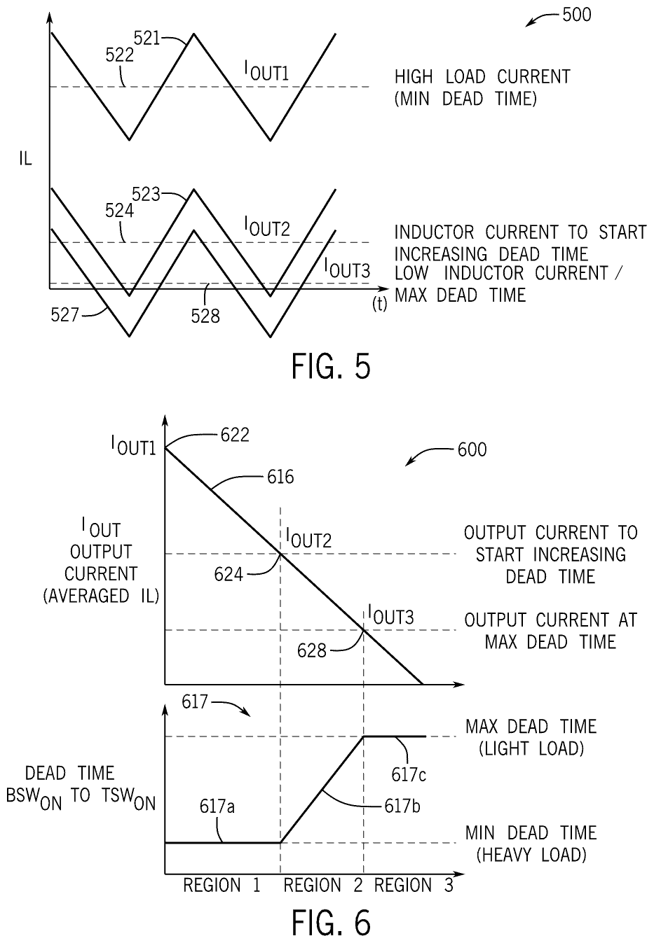

FIG. 5 illustrates load current operating regions for a switching converter and desired dead times corresponding thereto. Plot 500 depicts exemplary load currents for three operating regions: a high load current region, for which a constant minimum dead time may be desired; a moderate load current region, for which increasing dead time in response to decreasing current may be desired; and a low current region for which a constant maximum dead time may be desired. The high current/high load region corresponds to a relatively higher load current Iout1, corresponding to an instantaneous current 521 with a triangular waveform as described above and an average current 522. The moderate current/moderate load region corresponds to a relatively lower load current Iout2, corresponding to an instantaneous current 523 with a triangular waveform as described above and an average current 524. The low current/low load region corresponds to a still lower load current Iout3, corresponding to an instantaneous current 527 with a triangular waveform as described above and an average current 528.

FIG. 6 further illustrates a plot 600 of the above-described load current regions and corresponding dead time selection by control circuitry 229 of a power converter. The respective regions are denoted Region 1, for the high load current region during which a constant minimum dead time is desired; Region 2, for the moderate load current region in which dead time increases with decreasing load current; and Region 3, for the low load current region in which dead time is constant at a maximum value. The upper portion of plot 600 depicts load current curve 616 decreasing the high load current value IOUT1 622 to zero, including a first threshold 624 IOUT2 corresponding to the output current below which it is desired to start increasing dead time and a second threshold 628 IOUT3 corresponding to the output current below which it is desired to maintain the dead time at a maximum value. The lower portion of plot 600 depicts corresponding dead time curve 617, showing a constant minimum dead time 617a for load current below a first threshold 624 IOUT2, an increasing dead time 617b as current decreases from the first threshold 624 IOUT2 to the second threshold 628 IOUT3, and a constant maximum dead time 617c for load current values above the second threshold 628 IOUT3.

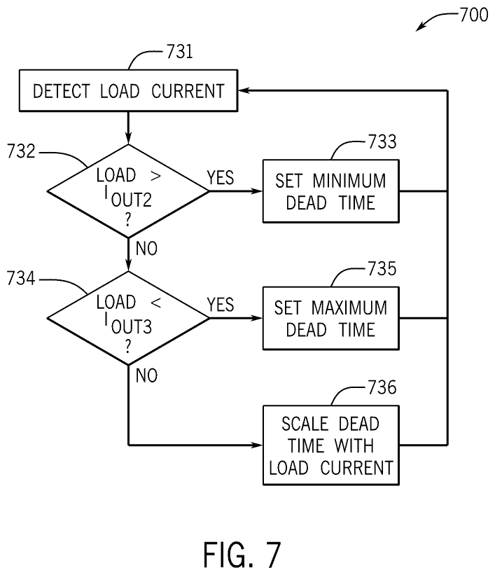

FIG. 7 illustrates a flow chart 700 of a dead time selection technique that can be employed by a switching power converter, e.g., by control circuitry 229 of a power supply system. Beginning with block 731, the control circuitry can detect the load current. In block 732, the control circuitry can determine if the load current is greater than a first threshold (e.g., IOUT2, discussed above). If so, then the system can be inferred to be in a high or heavy load condition, and the control circuitry can set a minimum dead time (block 733). Otherwise, if in block 734, the control circuitry can determine if the load current is less than a second threshold (e.g., IOUT3, discussed above). If so, then the system can be inferred to be in a low or light load condition, and the control circuitry can set a maximum dead time (block 735). Otherwise, meaning if the current is between the first and second thresholds, the system can be inferred to be in a moderate load condition in which it is desired to scale the dead time with the load current (block 736), increasing the dead time as the load current decreases and vice-versa. In some cases, this can include linearly increasing the dead time from the minimum value to the maximum value in inverse proportion to the load current. In other cases, the rate of increase could be determined in another fashion, such as stepwise between one or more intermediate thresholds, defined according to a higher order polynomial, etc.

In some cases the maximum allowed dead time, i.e., the constant maximum dead time for load currents below the second threshold, the dead time can be determined by:

$$DeadTime \leq \frac{π \sqrt{LC}}{2}$$

where L is the converter inductance (e.g., the value of the output inductor) and C is the switch node parasitic capacitance seen at the switch node. The minimum dead time can be selected to be as close to zero as possible, depending on other constraints of the system, such as the time required for the switching devices to transition from the on state to the off state and vice-versa.

In some implementations, such as a FCCM converter that uses peak current mode control, the technique described below may be used to determine conditions for Regions 1, 2, and 3, i.e., the high load, moderate load, and low load regions described above, with a linear increase in dead time versus a decrease in output current. Let VC represent the output voltage of a compensation amplifier contained in control circuitry 229. For peak current mode control, VC can be proportional to peak inductor current, i.e., the peak current being commanded by an inner current-mode control loop of the control circuitry. A compensating ramp (slope compensation) can be subtracted from the VC amplitude (to prevent subharmonic oscillation), and this difference can be applied to the current comparator, with VC′ indicating the difference. As a result, VC′ would be the commanding voltage for peak inductor current. The other input to the current comparator can be a voltage proportional to the sensed inductor current (Vind). If this sensed voltage Vind is averaged with a low-pass filter with bandwidth somewhat lower than the switching frequency of the converter, then this filtered signal (Vind′) should be proportional to output current.

It can thus be shown that the minimum inductor current will be approximately zero when:

$${V}_{IND}^{′} = \frac{{V C}^{′}}{2}$$

To achieve sufficient charging of switch node capacitance, the minimum inductor current should be sufficiently negative, with the exact value depending on conditions such as switch capacitance Coss, output inductance L, etc. If a minimum inductor current is specified as I_{Lmin}, and the sensed voltage proportional to I_{Lmin} is V_{ILmin} (as noted above), then:

$${V}_{IND}^{′} = \frac{{V C}^{′} + {V}_{ILMIN}}{2}$$

This equation can govern the transition from the high load region, where dead time can be held at a constant minimum value, to the moderate load region, where dead time can increase with decreasing load current.

As noted above, the min dead-time is converter design dependent, limited by the condition that dead-time be greater than 0, with the max dead-time given by:

$$DeadTime \leq \frac{π \sqrt{LC}}{2}$$

as described above. With the preceding three equations being known/given by the design of the converter, all that remains to define all three load current regions is to specify the slope of dead-time (DT) vs output current (V_{IND}′), which can be given by:

$$Slope = \frac{DT}{{V}_{IND}^{′}}$$

This linear slope may be used as a degree of freedom by which to optimize the converter's efficiency over a VIN and VOUT range of interest.

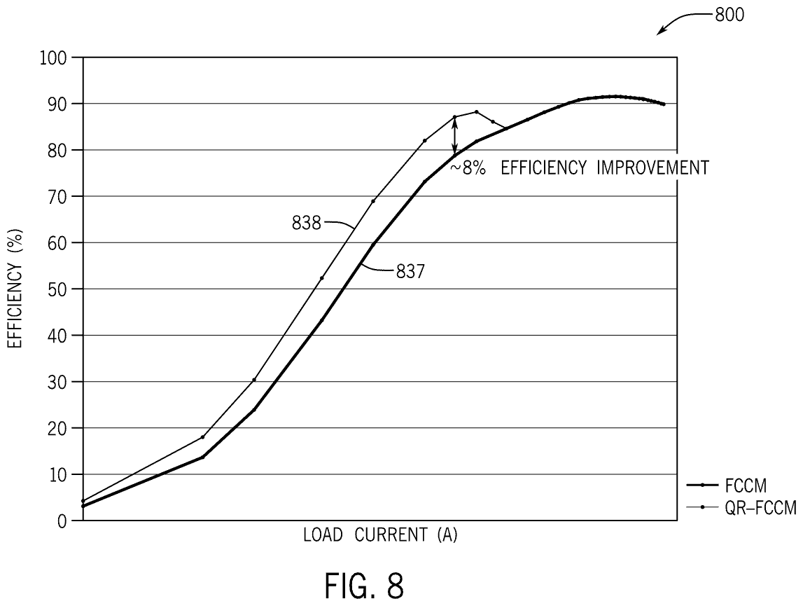

FIG. 8 illustrates an example efficiency plot 800 for an example switching converter using fixed dead time versus adaptive dead time as described herein. While these curves are for specific and corresponding operating conditions, the general principles illustrated would be applicable to different converters and/or different operating conditions. Curve 837 depicts an efficiency curve for a converter without the adaptive dead time compensation techniques described herein, while curve 838 depicts an efficiency curve for a converter with the adaptive dead time compensation techniques described herein. As can be seen, under light to moderate load conditions, there can be a significant increase in efficiency by applying the dead time adaptation techniques as described herein.

The foregoing describes exemplary embodiments of power supply circuitry with adaptive dead time for various load conditions. Such configurations may be used in a variety of applications but may be particularly advantageous when used in conjunction with display systems for electronic devices such as desktop or notebook computers, smartphones, smartwatches, tablet computers, and the like. Although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

1. A power converter comprising:
a switching half-bridge having a top switch and a bottom switch coupled at a switch node;
an energy storage element coupled to the switch node; and
control circuitry that:
operates the top switch and bottom switch in a fixed frequency pulse width modulation forced continuous conduction mode with an adjustable dead time between turning off one of the top and bottom switches and turning on another of the top and bottom switches;
monitors a load current of the power converter, the load current corresponding to a current through the energy storage element; and
responsive to a load current greater than a first threshold, sets the adjustable dead time to minimum dead time value;
responsive to a load current less than a second threshold, sets the adjustable dead time to a maximum dead time value; and
responsive to a load current between the first and second thresholds, sets the adjustable dead time to an intermediate dead time value between the minimum dead time value and the maximum dead time value.

2. The power converter of claim 1 wherein the intermediate dead time value is scaled to the load current.

3. The power converter of claim 1 wherein the adjustable dead time is a dead time between turning off the bottom switch and turning on the top switch.

4. The power converter of claim 1 wherein the switching half bridge, first circuitry, and second circuitry are a single integrated circuit.

5. The power converter of claim 1 wherein the switching half bridge, first circuitry, and second circuitry are contained in a single package.

6. The power converter of claim 1 wherein the energy storage element is an inductor.

7. The power converter of claim 6 wherein the power converter is a buck converter.

8. The power converter of claim 7 wherein the load current is an average current through the inductor.

9. The power converter of claim 1 wherein the load current is an average current through the energy storage element.

10. Control circuitry for a power converter, the control circuitry comprising:
first circuitry that operates a top switch and bottom switch of a switching half bridge in a fixed frequency pulse width modulation forced continuous conduction mode with an adjustable dead time between turning off one of the top and bottom switches and turning on another of the top and bottom switches;
second circuitry that monitors a load current of the power converter, the load current corresponding to a current through an energy storage element coupled to a switch node of the switching half bridge; and
responsive to a load current greater than a first threshold, sets the adjustable dead time to minimum dead time value;
responsive to a load current less than a second threshold, sets the adjustable dead time to a maximum dead time value; and
responsive to a load current between the first and second thresholds, sets the adjustable dead time to an intermediate dead time value between the minimum dead time value and the maximum dead time value.

11. The control circuitry of claim 10 wherein the intermediate dead time value is scaled to the load current.

12. The control circuitry of claim 10 wherein the adjustable dead time is a dead time between turning off the bottom switch and turning on the top switch.

13. The control circuitry of claim 10 wherein the switching half bridge, first circuitry, and second circuitry are a single integrated circuit.

14. The control circuitry of claim 10 wherein the switching half bridge, first circuitry, and second circuitry are contained in a single package.

15. The control circuitry of claim 10 wherein the:
the energy storage element is an inductor; and
the power converter is a buck converter.

16. The control circuitry of claim 15 wherein the load current is an average current through the inductor.

17. The control circuitry of claim 10 wherein the load current is an average current through the energy storage element.

18. A method of controlling a power converter, the method being performed by control circuitry of the power converter and comprising:
operating a top switch and bottom switch of a switching half bridge in a fixed frequency pulse width modulation forced continuous conduction mode with an adjustable dead time between turning off one of the top and bottom switches and turning on another of the top and bottom switches;
monitoring a load current of the power converter, the load current corresponding to a current through an energy storage element coupled to a switch node of the switching half bridge; and
responsive to a load current greater than a first threshold, setting the adjustable dead time to minimum dead time value;
responsive to a load current less than a second threshold, setting the adjustable dead time to a maximum dead time value; and
responsive to a load current between the first and second thresholds, setting the adjustable dead time to an intermediate dead time value between the minimum dead time value and the maximum dead time value.

19. The method of claim 18 wherein the intermediate dead time value is scaled to the load current.

20. The method of claim 18 wherein the adjustable dead time is a dead time between turning off the bottom switch and turning on the top switch.

21. The method of claim 18 wherein the load current is an average current through the energy storage element.
